(19) United States
(12) Patent Application Publication
(10) Pub. No.: US 2012/0024410 A1
(43) Pub. Date: Feb. 2, 2012

(54) Tailpipe Customization

(76) Inventor: Timothy Riley, Brazona, TX (US)

(21) Appl. No.: 13/184,797

(22) Filed: Jul. 18, 2011

Related U.S. Application Data
(60) Provisional application No. 61/369,679, filed on Jul. 31, 2010.

(51) Int. Cl. F16L 9/00; B23P 11/00

(52) U.S. Cl. 138/109; 29/525.11

(57) ABSTRACT

A tailpipe tip for inserting into a tailpipe opening comprising: a perimeter, where said perimeter fits into the tailpipe opening; an etched design within the perimeter, where said design allows for the movement of air there through; and a means to attach the tip to the tailpipe opening. In one exemplary embodiment, the means to attach includes bolts.

### CROSS REFERENCE TO OTHER APPLICATIONS

This application claims priority to U.S. Provisional Application Ser. No. 61/369,679 filed on Jul. 31, 2010.

### BACKGROUND OF THE INVENTION

1. Field of Invention The present invention relates to a tailpipe tip that is inserted over the tailpipe opening to provide a customization feature for a conventional tailpipe.

2. Description of Related Art

Most motor vehicles include at least one exhaust pipe that extends from the rear of the vehicle. Exhaust pipes provide a means to carry and emit toxic or noxious gases from the engine of a vehicle. Exhaust pipes are installed on motor vehicles, trucks, motorcycles and just about any vehicle, which uses an internal combustion engine. Exhaust pipes allow for the gases that are usually very hot to escape from the engine for emission into the environment. Exhaust pipes are usually placed in a position away from other objects or components that are sensitive to heat. The exhaust pipe becomes very hot during use and therefore any object placed near or close may burn if in contact with the pipe. The tail end of the exhaust pipe is visible from most rear ends of vehicles. The exhaust pipe extends from the manifold of the engine and is directed toward the rear of the car and most times passes through a catalytic converter system. Once beyond the catalytic converter system the tailpipe extends to the rear of the vehicle for the final exit point of noxious gases.

Exhaust tail pipes are made in single, dual or even quad designs. Since the end of the tailpipe is visible often this area of the tailpipe may be designed to have a visual pleasing appearance. Many times the tip of the tailpipe is chrome and may include a straight or angle edge. The opening of the tailpipe is usually left completely open to allow the movement of the gases through the tailpipe.

It would be advantageous to have a tailpipe accessory that is able to adorn and decorate the exit opening of a tailpipe. Many times the opening is left open to allow the movement of the gas through the tailpipe. It would be advantageous to have a tip that inserts over the opening that could provide an ornamental, decorative attachment to the tailpipe opening but yet allow movement of gases and airflow so that the tailpipe continues to function.

### SUMMARY OF THE INVENTION

The present invention relates to a tailpipe tip for inserting into a tailpipe opening comprising: a perimeter, where said perimeter fits into the tailpipe opening; an etched design within the perimeter, where said design allows for the movement of air there through; and a means to attach the tip to the tailpipe opening. In one exemplary embodiment, the means to attach includes bolts.

### BRIEF DESCRIPTION OF DRAWINGS

FIG. 1A depicts tailpipe tips according to the present invention.

FIG. 1B depicts the installation of the tailpipe tips according to the present invention onto tailpipe opening.

### DETAILED DESCRIPTION

The present invention relates to a tip that is utilized to customize a tailpipe opening. The tip is installed to fit over the end opening of a tailpipe. The ornamental tip includes an ornamental design that allows for the flow of exhaust through the ornamental design once attached to the tailpipe. The tailpipe tip according to the present invention adds a stylish, customized design to the tailpipe but yet allows adequate airflow to enable the proper functioning of the tailpipe.

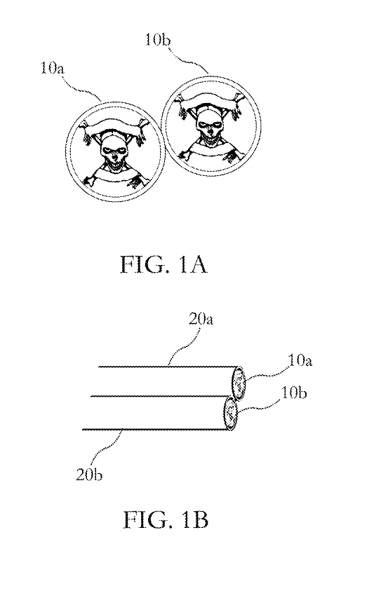

In reference to FIG. 1 tailpipe tip 10a, 10b according to the present invention are depicted. The tailpipe tips 10a, 10b provide a means to customize and adorn a vehicle tailpipe. The tip according to the present invention is a device that includes an ornamental design etched within the perimeter of the tailpipe tip. The ornamental design is a stenciled-type of design that enables the flow of air through the tip. The stencil figure is created of any customized shape, design or figure that is suitable for the user. The tailpipe tip according to the present invention is placed over the opening of the tailpipe and secured into place through the use of bolts. The tailpipe tips 10a, 10b are interchangeable and therefore a user may use various tailpipe tips if desired.

The tailpipe tips 10a, 10b may be made of stainless steel materials in order to prevent rust or further modified with a chrome finish. FIG. 1B depicts the insertion of tailpipe tips 10a, 10b into a pair of tailpipes 20a, 20b. As shown the tailpipe tips 10a, 10b insert into the opening of the tailpipes 20a, 20b and therefore provides a means to customize and adorn a tailpipe.

The tailpipe tip according to the present invention provides a means for the user to personalize the end opening of a tailpipe and for the installation of various designs of characters, people's logos or even sports emblems that would be etched into a stenciled design within the circumference of the tailpipe tip. These tailpipe tips may be further customized to fit various types of exhaust pipes and are bolted into place for use. Preferably the tailpipe tips are made of stainless steel metal in order to prevent rust and to allow for optimized use on the opening of the exhaust pipe. The instant invention has been shown and described in what it considers to be the most practical and preferred embodiments. It is recognized, however, that departures may be made there from within the scope of the invention and that obvious modifications will occur to a person skilled in the art.

What is claimed is:

1. A tailpipe tip for inserting into a tailpipe opening comprising:
a. a perimeter, where said perimeter fits into the tailpipe opening;
b. an etched design within the perimeter, where said design allows for the movement of air there through; and
c. a means to attach the tip to the tailpipe opening.

2. The tailpipe tip according to claim 1 where said means to attach includes bolts.

3. A method of decorating a tailpipe comprising the steps of:
a. inserting a tailpipe tip onto an opening of a tailpipe; and
b. securing the tip into the opening.

4. The method of decorating according to claim 3 where said step of securing includes inserting bolts through the tailpipe into the tip.
